(19) United States
(12) Patent Application Publication
(10) Pub. No.: US 2024/0221764 A1
(43) Pub. Date: Jul. 4, 2024

(54) SOUND DETECTION METHOD AND RELATED DEVICE

(71) Applicant: Hangzhou Meari Technology Co.,Ltd., Hangzhou (CN)

(72) Inventors: Haijun Gu, Hangzhou (CN); Gangqiang Zhao, Hangzhou (CN); Wei Jin, Hangzhou (CN); Hongli Ying, Hangzhou (CN)

(21) Appl. No.: 18/400,196

(22) Filed: Dec. 29, 2023

(30) Foreign Application Priority Data
Jan. 3, 2023 (CN) 202310000609.8

(51) Int. Cl. G10L 19/02; G01H 17/00; G10L 25/06; G10L 25/18; G10L 25/27

(52) U.S. Cl. CPC G10L 19/02; G01H 17/00; G10L 25/06; G10L 25/18; G10L 25/27

(57) ABSTRACT

Disclosed in the present application are a sound detection method and apparatus, an electronic device and a computer-readable storage medium. The method includes: acquiring audio and video data about a target object, and extracting and obtaining audio data and image data from the audio and video data; performing feature extraction on the audio data and the image data respectively to obtain an audio feature and an image feature; inputting the audio feature and the image feature into a sound source positioning model for processing; and, when the sound source positioning model outputs a sound source positioning image about the target object, identifying the sound source positioning image and the audio feature by using a multi-modal feature fusion model, and determining whether target audio of the target object exists in the audio and video data.

### CROSS-REFERENCE TO RELATED APPLICATIONS

This is a U.S. patent application which claims the priority and benefit of Chinese Patent Application Number 202310000609.8, filed on Jan. 3, 2023, the disclosure of which is incorporated herein by reference in its entirety.

### FIELD OF TECHNOLOGY

The present application relates to the field of multimedia, and in particular, to a sound detection method, a sound detection apparatus, an electronic device, and a computer-readable storage medium.

### BACKGROUND

With the acceleration of rhythm of life, it is difficult for a family in a legitimate stage to accompany a baby all the time, which results in a problem of not being able to provide timely care to the baby and the baby's need for the outside world is often expressed through crying. Therefore, it is particularly important to detect the crying of the baby through a smart device and give timely feedback to a parent.

At present, a common method of baby crying detection is mainly through extraction of audio spectrum characteristics. However, this method has a high requirement for the extracted audio features. Single use of the audio features is prone to false alarms for some confusing sounds (such as cat sounds, wooden door opening sounds, birds' sounds, babies' smiling sounds, children's screaming sounds, conversation sounds), and is prone to omission of reporting for some small crying sounds of babies.

Therefore, how to effectively reduce the problems of missed detection and false detection and improve the accuracy of a sound detection result is an urgent problem to be solved by a person skilled in the art.

### SUMMARY

The object of the present application is to provide a sound detection method, which can effectively reduce the problems of missed detection and false detection, and improve the accuracy of a sound detection result. Another object of the present application is to provide a sound detection apparatus, an electronic device and a computer-readable storage medium, which all have the above beneficial effects.

According to a first aspect, the present application provides a sound detection method, comprising:
acquiring audio and video data about a target object, and extracting and obtaining audio data and image data from the audio and video data;
performing feature extraction on the audio data and the image data respectively to obtain an audio feature and an image feature;
inputting the audio feature and the image feature into a sound source positioning model for processing; and
when the sound source positioning model outputs a sound source positioning image about the target object, identifying the sound source positioning image and the audio feature by using a multi-modal feature fusion model, and determining whether target audio of the target object exists in the audio and video data.

Alternatively, the step of performing feature extraction on the audio data and the image data respectively to obtain an audio feature and an image feature comprises:
calculating a spectral coefficient of the audio data, and performing feature extraction on the spectral coefficient by using an audio feature extraction model to obtain the audio feature; and
performing the feature extraction on the image data by using an image feature extraction model to obtain the image feature.

Alternatively, a construction process of the sound source positioning model comprises:
acquiring audio and video samples, and performing extraction in the audio and video samples to obtain positive audio samples, negative audio samples, positive image samples, and negative image samples;
identifying each of the positive audio samples to obtain volume values;
combining the positive audio samples with volume values not lower than a preset threshold with the positive image samples into strong positive samples;
combining the negative audio samples and the negative image samples into negative samples; and
training an initial sound source positioning model by using the strong positive samples and the negative samples to obtain the sound source positioning model.

Alternatively, a construction process of the multi-modal feature fusion model comprises:
processing each of the strong positive samples and each of the negative samples by using the sound source positioning model to obtain each processing result, and determining a priori parameter corresponding to each processing result, wherein the processing results comprise outputting a first sound source positioning image about the target object, outputting a second sound source positioning image about other objects, and no output;
when the processing result of the strong positive sample is to output the first sound source positioning image, combining the first sound source positioning image and the positive audio sample in the strong positive sample into a first positive sample;
when the processing result of the strong positive sample is to output the second sound source positioning image or no output, acquiring a target object calibration result of the positive image sample in the strong positive sample, and combining the target object calibration result and the positive audio sample in the strong positive sample into a second positive sample;
when the processing result of the negative sample is to output the first sound source positioning image, combining the first sound source positioning image and the negative audio sample in the negative sample into a first negative sample;
when the processing result of the negative sample is to output the second sound source positioning image, combining the second sound source positioning image and the negative audio sample in the negative sample into a second negative sample;
when the processing result of the negative sample is no output, acquiring other object calibration results in the negative image sample in the negative sample, and combining the other object calibration results and the negative audio samples in the negative sample into a third negative sample;
combining the first positive sample and the second positive sample into a positive sample set, and combining the first negative sample, the second negative sample and the third negative sample into a negative sample set; and
performing model training according to the positive sample set, the negative sample set, and all the priori parameters to obtain the multi-modal feature fusion model.

Alternatively, the sound detection method further comprises:
combining the positive audio samples with the volume values lower than the preset threshold with the positive image sample data into weak positive samples;
performing training by using the multi-modal feature fusion model and the weak positive samples to obtain a student model; and
performing parameter updating on the multi-modal feature fusion model by using the student model to obtain an updated multi-modal feature fusion model.

Alternatively, the step of identifying the sound source positioning image and the audio feature by using a multi-modal feature fusion model comprises:
determining whether customization information is received, where the customization information is a target audio and video sample about the target object;
if yes, performing model optimization on the multi-modal feature fusion model by using the target audio and video sample to obtain an optimized multi-modal feature fusion model; and
identifying the sound source positioning image and the audio feature by using the optimized multi-modal feature fusion model.

Alternatively, the sound detection method further comprises:
when the sound source positioning model does not output the sound source positioning image about the target object, determining that there is no target audio of the target object in the audio and video data.

According to a second aspect, the present application further discloses a sound detection apparatus, comprising:
an acquiring module, configured to acquire audio and video data about a target object, and extracting and obtaining audio data and image data from the audio and video data;
an extraction module, configured to perform feature extraction on the audio data and the image data respectively to obtain an audio feature and an image feature;
an input module, configured to input the audio feature and the image feature into a sound source positioning model for processing; and
an identifying module, configured to, when the sound source positioning model outputs a sound source positioning image about the target object, identify the sound source positioning image and the audio feature by using a multi-modal feature fusion model, and determine whether target audio of the target object exists in the audio and video data.

According to a third aspect, the present application further discloses an electronic device, comprising:
a memory, configured to store a computer program; and
a processor, configured to implement the steps of any sound detection method as described above when executing the computer program.

According to a fourth aspect, the present application further discloses a computer-readable storage medium, wherein the computer-readable storage medium stores a computer program, and the computer program, when being executed by a processor, implements the steps of any sound detection method as described above.

The present application provides a sound detection method, comprising: acquiring audio and video data about a target object, and extracting and obtaining audio data and image data from the audio and video data; performing feature extraction on the audio data and the image data respectively to obtain an audio feature and an image feature; inputting the audio feature and the image feature into a sound source positioning model for processing; and, when the sound source positioning model outputs a sound source positioning image about the target object, identifying the sound source positioning image and the audio feature by using a multi-modal feature fusion model, and determining whether target audio of the target object exists in the audio and video data.

According to the technical solution provided in the present application, firstly, the audio and video data is acquired, and the audio data and the image data are extracted from the audio and video data respectively; then, the audio features of the audio data and the image features of the image data are processed by using the sound source positioning model to acquire the sound source positioning image about the target object; and finally, the multi-modal feature fusion model is used to process the sound source positioning image and the audio features of the audio data, so as to determine whether there is the target sound related to the target object in the audio and video data, thereby realizing the sound detection. Obviously, this implementation method can realize the sound detection of multi-modal feature. Compared with the sound detection of a single modal feature, it can effectively reduce the problems of missed detection and false detection, so as to improve the accuracy of the sound detection results.

The sound detection apparatus, the electronic device, and the computer-readable storage medium provided in the present application also have the above technical effects, and details are not described herein again.

### BRIEF DESCRIPTION OF THE DRAWINGS

In order to more clearly illustrate the prior art and the technical solution in embodiments of this application, accompanying drawings needed to be used in the description of the prior art and the embodiments of this application are briefly described below. Of course, the following description of the drawings in the embodiments of the present application is merely a part of the embodiments of the present application, and for a person of ordinary skill in the art, other drawings may be obtained according to the provided drawings without involving any inventive effort, and the other drawings obtained are also within the protection scope of the present application.

FIG. 1 is a schematic flowchart of a sound detection method provided by the present application;

FIG. 2 is a schematic flowchart of a baby crying detection method provided by the present application;

FIG. 3 is a schematic structural diagram of a sound detection apparatus provided by the present application; and

FIG. 4 is a schematic structural diagram of an electronic device provided by the present application.

### DESCRIPTION OF THE EMBODIMENTS

The core of the present application is to provide a sound detection method, which can effectively reduce the problems of missed detection and false detection, and improve the accuracy of a sound detection result. Another core of the present application is to provide a sound detection apparatus, an electronic device and a computer-readable storage medium, which all have the above beneficial effects.

In order to more clearly and completely describe the technical solution in the embodiments of this application, the technical solution in the embodiments of this application will be described below with reference to the accompanying drawings in the embodiments of this application.

Obviously, the described embodiments are only a part of the embodiments of the present application, and are not all embodiments. All other embodiments obtained by a person of ordinary skill in the art based on the embodiments of the present application without involving any inventive effort shall fall within the protection scope of the present application.

An embodiment of the present application provides a sound detection method.

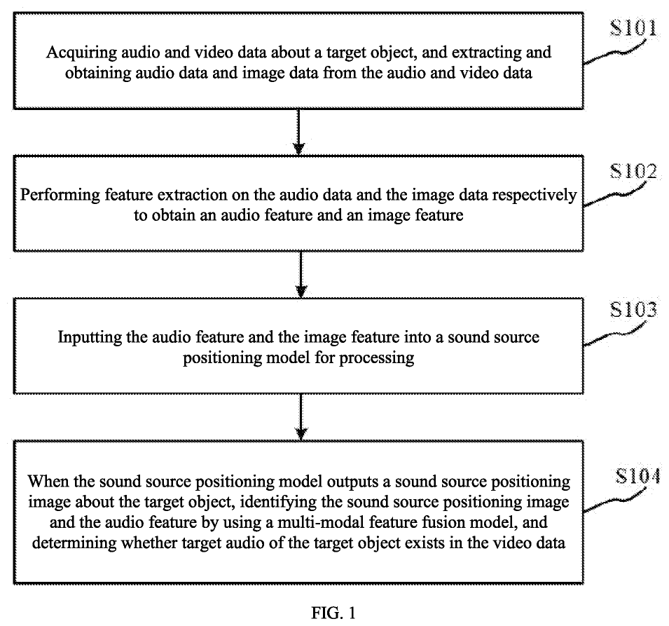

Referring to FIG. 1, FIG. 1 is a schematic flowchart of a sound detection method provided by the present application, and the sound detection method may comprise S101 to S104.

S101: acquiring audio and video data about a target object, and extracting and obtaining audio data and image data from the audio and video data.

This step is intended to achieve the acquisition of the audio and video data, and the extraction of the audio data and the image data in the audio and video data. The audio and video data is audio and video data about the target object, and can be collected by using a video collected device, and the target object is an object that needs to be subjected to sound detection. For example, when a baby crying detection needs to be performed, the baby is the target object. Further, the audio data and the image data are extracted from the audio and video data.

The image data refers to image frames extracted from the audio and video data. In order to reduce the amount of calculation and improve the detection efficiency, a small amount of image data may be extracted according to a preset time interval, for example, 10 pieces of image data may be extracted every 3 seconds. The audio data refers to audio clips extracted from the audio and video data, which may be complete audio clips. Similarly, in order to reduce the amount of calculation, short audio clips may be extracted according to a preset time interval, for example, audio data with a duration of 5 seconds may be extracted every 3 seconds. Certainly, the time interval of data extraction, the number of pieces of image data in a single extraction, and a duration of a single extraction of the video data do not affect the implementation of the technical solution, and may be set by a person skilled in the art according to actual needs, which is not limited in this application.

S102: performing feature extraction on the audio data and the image data respectively to obtain an audio feature and an image feature.

This step is intended to achieve the extraction of the audio feature and the image feature. After the audio data and the image data are obtained based on the audio and video data, the feature extraction can be performed on the audio data and the image data respectively to obtain the corresponding audio feature and image feature, so as to facilitate subsequent sound detection based on these features.

The feature extraction may be implemented based on a corresponding network model. In a possible implementation, the step of performing the feature extraction on the audio data and the image data respectively to obtain an audio feature and an image feature may comprises: calculating a spectral coefficient of the audio data, and performing the feature extraction on the spectral coefficient by using an audio feature extraction model to obtain the audio feature; and performing the feature extraction on the image data by using an image feature extraction model to obtain the image feature.

It can be understood that according to the auditory features of human ears, it can be seen that the human ears have selectivity to the frequency and cannot effectively distinguish all the frequency components, and therefore, for the audio data, the original sound features can be characterized effectively by using a Mayer cepstrum coefficient, which is similar to the hearing mechanism of the human ears, to calculate spectrum characteristics. On this basis, for the audio data, the spectral coefficient of the audio data may be calculated first, and then be input to an audio feature extraction model for the feature extraction to obtain the corresponding audio feature; and for the image data, the image data may be directly input to an image feature extraction model for the feature extraction to obtain the corresponding image feature.

The audio feature extraction model and the image feature extraction model may be obtained by training with a deep convolutional neural network having the same framework, and in a possible implementation, the deep convolutional neural network may be a resnet-18 residual network.

S103: inputting the audio feature and the image feature into a sound source positioning model for processing.

This step is intended to implement feature data processing based on a sound source positioning model. Specifically, after the audio feature of the audio data and the image feature of the image data are obtained, the audio feature and the image feature may be input to the sound source positioning model for processing. The sound source positioning model is a network model for realizing sound source positioning, can be pre-stored in a corresponding storage space, and can be directly called during use. Specifically, the sound source positioning model may obtain a sound source positioning image by performing recognition processing on the audio feature and the image feature, and the sound source positioning image is used to display position information of each position where sound is emitted. Of course, the sound positioning image may be a sound source positioning map about the target object (for example, a position where baby crying is displayed). It may also be a sound source positioning image for other objects (other than the target object) (such as a position where a pet barking is displayed). In addition, of course, there are cases where the sound source location model does not output the sound source positioning image, which obviously corresponds to a scene where the current environment is relatively quiet.

S104: when the sound source positioning model outputs a sound source positioning image about the target object, identifying the sound source positioning image and the audio feature by using a multi-modal feature fusion model, and determining whether target audio of the target object exists in the audio and video data.

This step is intended to achieve a final sound detection to determine whether the target audio of the target object exists in the audio and video data. Specifically, when the sound source positioning model outputs the sound source positioning image and the sound source positioning image is a sound source positioning graph about the target object, a multi-modal feature fusion model can be further called, the sound source positioning image and the audio features output by the sound source positioning model are input into the multi-modal feature fusion model for secondary recognition, and an output of the multi-modal feature fusion model is a final sound detection result.

It can be understood that based on the multi-modal feature fusion model, not only sound detection of a multi-modal feature is realized, but also secondary sound detection is also realized, so that a final sound detection result can be remarkably improved. For example, in a baby crying detection scenes, although false alarms for most similar baby cryings can be solved on the basis of the sound source positioning model, for some sounds emitted by baby (such as short crying, laughter, talking of the baby), there is a high probability that it happens on the baby, and it is impossible to accurately distinguish whether it is a false detection resulted from the baby crying. In some special audio and video scenes, when the audio sound is relatively small or there is no obvious sound (such as when there is a fault in a microphone), but there is a baby crying in a video image, the sound source positioning model has almost no effect, resulting in missed detection. For such problems, the present application combines the sound source positioning model and the multi-modal feature fusion model to realize the sound detection, which obviously reduces the problems of missed detection and false detection.

As stated above, feature data processing based on the sound source positioning model also has a situation that the sound source positioning model does not output the sound source positioning image, and it is obvious that the situation corresponds to a scene that the current environment is quiet. Therefore, in one embodiment of the present application, the sound detection method may further comprise: when the sound source positioning model does not output the sound source positioning image about the target object, it is determined that the target audio of the target object does not exist in the audio and video data.

It can be seen that in the sound detection method provided in the embodiment of the present application, firstly, the audio and video data is acquired, and the audio data and the image data are extracted from the audio and video data respectively; then, the audio features of the audio data and the image features of the image data are processed by using the sound source positioning model to acquire the sound source positioning image about the target object; and finally, the multi-modal feature fusion model is used to process the sound source positioning image and the audio features of the audio data, so as to determine whether there is the target sound related to the target object in the audio and video data, thereby realizing the sound detection. Obviously, this implementation method can realize the sound detection of multi-modal feature. Compared with the sound detection of a single modal feature, it can effectively reduce the problems of missed detection and false detection, so as to improve the accuracy of the sound detection results.

On the basis of the above embodiments:

In an embodiment of the present application, the construction process of the sound source positioning model may comprise:
acquiring audio and video samples, and performing extraction in the audio and video samples to obtain positive audio samples, negative audio samples, positive image samples, and negative image samples;
identifying each of the positive audio samples to obtain volume values;
combining the positive audio samples with volume values not lower than a preset threshold with the positive image samples into strong positive samples;
combining the negative audio samples and the negative image samples into negative samples; and
training an initial sound source positioning model by using the strong positive samples and the negative samples to obtain the sound source positioning model.

An embodiment of the present application provides a construction method of the sound source positioning model. First, audio and video samples are acquired, and in order to implement model training, a large number of audio and video samples should be used herein; for each audio and video sample, a positive audio sample, a negative audio sample, a positive image sample, and a negative image sample are extracted, wherein the positive audio sample refers to an audio sample that contains the target sound of the target object (the sound type specified here aims to achieve the sound detection of the corresponding type), and the negative audio sample refers to an audio sample that contains sound information of other objects except the target object, and the positive image sample refers to an image sample containing the target object which is performing an action resulting in the target sound, and the negative image sample refers to an image sample containing no target object or only containing the target object which does not perform an action resulting in the target sound. Further, for each positive audio sample, volume identification can be performed on the positive audio sample to obtain positive audio samples of which volume values is not lower than a preset threshold, and the positive audio samples with the volume value not lower than the preset threshold and the positive image samples are combined into strong positive samples to serve as positive samples for training the sound source positioning model, and the negative audio samples and the negative image samples are combined into negative samples to serve as negative samples for training the sound source positioning model, wherein the value of the preset threshold is set by a person skilled in the art according to actual needs, which is not limited in this application. Finally, an initial sound source positioning model is trained by using the strong positive samples and the negative samples to obtain the sound source positioning model, wherein the initial sound source positioning model may be an initial model built on the basis of a neural network model, and the initial sound source positioning model is trained by using the strong positive samples and the negative samples to obtain a final sound source positioning model, which may also be a common sound source positioning model in a traditional technology, and the final sound source positioning model can be obtained by performing parameter tuning on the common sound source positioning model by using the strong positive samples and the negative samples.

In an embodiment of the present application, a construction process of the multi-modal feature fusion model may comprise:
processing each of the strong positive samples and each of the negative samples by using the sound source positioning model to obtain each processing result, and determining a priori parameter corresponding to each processing result, wherein the processing results comprise outputting a first sound source positioning image about the target object, outputting a second sound source positioning image about other objects, and no output;
when the processing result of the strong positive sample is to output the first sound source positioning image, combining the first sound source positioning image and the positive audio sample in the strong positive sample into a first positive sample;
when the processing result of the strong positive sample is to output the second sound source positioning image or no output, acquiring a target object calibration result of the positive image sample in the strong positive sample, and combining the target object calibration result and the positive audio sample in the strong positive sample into a second positive sample;
when the processing result of the negative sample is to output the first sound source positioning image, combining the first sound source positioning image and the negative audio sample in the negative sample into a first negative sample;
when the processing result of the negative sample is to output the second sound source positioning image, combining the second sound source positioning image and the negative audio sample in the negative sample into a second negative sample;
when the processing result of the negative sample is no output, acquiring other object calibration results in the negative image sample in the negative sample, and combining the other object calibration results and the negative audio samples in the negative sample into a third negative sample;
combining the first positive sample and the second positive sample into a positive sample set, and combining the first negative sample, the second negative sample and the third negative sample into a negative sample set; and
performing model training according to the positive sample set, the negative sample set, and all the priori parameters to obtain the multi-modal feature fusion model.

An embodiment of the present application provides a construction method of the multi-modal feature fusion model, wherein training samples of the multi-modal feature fusion model are generated based on processing results of the sound source positioning model on sample data. First, after the training of the sound source positioning model is completed, each strong positive sample and each negative sample may be processed respectively by using the sound source positioning model to obtain a processing result corresponding to each piece of sample data, and the processing results may be divided into the following three cases: outputting a first sound source positioning image about the target object, outputting a second sound source positioning image about other objects, and no output. On this basis, corresponding priori parameters are determined according to each processing result, wherein the priori parameters are parameter information used for implementing the training of the multi-modal feature fusion model. For different processing results, the priori parameters correspond to different values, that is, the priori parameters are determined by the processing results. Further, for different processing results, a sample data set for performing the training of the multi-modal feature fusion model is divided, including a positive sample data set and a negative sample data set:

1. For the strong positive samples:
when the processing result of the strong positive sample is to output the first sound source positioning image, combining the first sound source positioning image and the positive audio sample in the strong positive sample into a first positive sample; and
when the processing result of the strong positive sample is to output the second sound source positioning image or no output, manually calibrating by a person skilled in the art the positive image sample in the strong positive sample, obtaining the calibration result about the target object, and combining the calibration result of the target object and the positive audio sample in the strong positive sample into the second positive sample.

Finally, all the first positive samples and all the second positive samples are combined into the positive sample set, which is used as the positive samples for the training of the multi-modal feature fusion model.

2. For the negative samples:
when the processing result of the negative sample is to output the first sound source positioning image, combining the first sound source positioning image and the negative audio sample in the negative sample into a first negative sample;
when the processing result of the negative sample is to output the second sound source positioning image, combining the second sound source positioning image and the negative audio sample in the negative sample into a second negative sample; and
when the processing result of the strong positive sample is no output, manually calibrating by a person skilled in the art the negative image sample in the negative sample, obtaining the calibration result about the other objects, and combining the calibration result of the other objects and the negative audio sample in the negative sample into the third negative sample.

Finally, all the first negative samples, all the second negative samples and all the third negative samples are combined into the negative sample set, which is used as the negative samples for the training of the multi-modal feature fusion model.

Therefore, model training may be performed by using the positive sample set, the negative sample set, and corresponding priori parameters of all the samples in all the sample set to obtain a final multi-modal feature fusion model.

In an embodiment of the present application, the sound detection method may also comprise:
combining the positive audio samples with volume values lower than a preset threshold with the data of the positive image samples into weak positive samples;
performing training by using the multi-modal feature fusion model and the weak positive samples to obtain a student model; and
performing parameter updating on the multi-modal feature fusion model by using the student model to obtain an updated multi-modal feature fusion model.

In order to effectively improve the accuracy of the model, the accuracy of the sound detection result is further improved, and the parameters of the multi-modal feature fusion model trained in the previous embodiment can continue to be updated to obtain a multi-modal feature fusion model suitable for both high-volume and low-volume scenes.

Specifically, in the construction process of the sound source positioning model, for the positive audio samples with the volume values lower than the preset threshold, the positive audio samples and the positive image samples can be combined into weak positive samples, so that the weak positive samples can be used for continuously updating the parameters of the multi-modal feature fusion model. First, the obtained multi-modal feature fusion model is used as a teacher model, and a student model is obtained by training in combination with weak positive samples; and then, parameters in the teacher model are updated by using the student model in an exponential moving average value manner, so as to obtain an updated teacher model, that is, the updated multi-modal feature fusion model. Obviously, since the updated multi-modal feature fusion model is obtained by updating the weak positive samples containing the positive audio samples with the volume values lower than the preset threshold, and the multi-modal feature fusion model obtained in the previous embodiment is obtained by training the strong positive samples containing the positive audio samples with the volume values not lower than the preset threshold. Therefore, the updated multi-modal feature fusion model can be suitable for the high-volume scene and the low-volume scene at the same time, and the accuracy of the sound detection result is ensured.

In an embodiment of the present application, the step of identifying the sound source positioning image and the audio feature by using a multi-modal feature fusion model may comprise:
determining whether customization information is received, where the customization information is a target audio and video sample about the target object;
if yes, performing model optimization on the multi-modal feature fusion model by using the target audio and video sample to obtain an optimized multi-modal feature fusion model; and
identifying the sound source positioning image and the audio feature by using the optimized multi-modal feature fusion model.

The embodiment of the present application provides a method for implementing sound detection based on a customized multi-modal feature fusion model, which can meet the customization requirements of different users, and can improve the accuracy of the sound detection result.

It can be understood that sample data sources used for the training of multi-modal feature fusion model are different. For example, in the baby crying detection scene, sample data used for the training of multi-modal feature fusion model must be from different baby crying samples. On this basis, in order to achieve sound detection for a specific target object, customized information containing target audio and video samples about the specific target object can be obtained, and the multi-modal feature fusion model can be optimized based on these target audio and video samples, and the optimized multi-modal feature fusion model can be obtained. In this case, the optimized multi-modal feature fusion model must be a network model most suitable for the aforementioned specific target object. Finally, the optimized multi-modal feature fusion model is used to continue the sound detection. Obviously, the detection result has higher accuracy.

On the basis of the above embodiments, an embodiment of this application provides another sound detection method. The sound detection method provided in the embodiment of this application takes baby crying detection as an example, and its implementation process is as follows:

### I. Model Training:

1. Sample data acquisition:

Audio and video of baby crying appearing in a home scene are collected, a manual selection is performed, and a database is established. For the collected audio and video data, the collected audio and video data may be truncated once every 3 seconds, and if a segment of audio and video contains the baby crying and also contains an image in which the baby is crying, in this period of time, an image of a baby being crying is selected, and paired with the audio to form a pair of strong positive samples. If the volume of the segment of sound is small or there is no sound, but the baby in the video does cry, the image in which the baby is crying is selected and a face is calibrated, and the calibrated image is paired with the audio to form a pair of weak positive samples. Meanwhile, it is also necessary to collect a comparison training sample set similar to the baby crying (which may also be used for the negative samples), including audio and video pairing data sets in common scenes such as cat meowing, wooden door switching, train running, bird chirping, and images of various non-baby crying as negative samples.

2. Feature data extraction:

For an audio sample in each piece of the sample data, a Mel cepstrum coefficient thereof is calculated, and feature extraction is performed on the audio sample by using a deep convolutional neural network to obtain a corresponding audio feature. For an image sample in each piece of the sample data, feature extraction is performed by using a deep convolutional neural network having the same frame, and a corresponding image feature is obtained.

3. Training of sound source positioning model and data processing thereof:
performing a fine adjustment of network parameters of an initial sound source positioning model provided in an EZ-VSL algorithm by using the strong positive sample data set and the negative sample data set to obtain the final sound source positioning model.
performing a network parameter fine adjustment on an initial sound source positioning model provided in an EZ-VSL algorithm by using the strong positive sample data set and the negative sample data set to obtain a positioning result.

4. Positioning result classification:

If the sound source positioning model outputs the sound source positioning image, a pre-processing such as scaling and edge supplementing is performed on the sound source positioning image, and then the pre-processed sound source positioning image is sent to the deep convolutional neural network for classification to determine whether the sound source positioning image is a sound source positioning image of the baby. If the sound source positioning model has no output, a next determination may be performed according to the actual situation.

(1) For the strong positive samples:
(a) When the sound source positioning image is output, if a classification confidence score of the sound source positioning image is greater than or equal to a preset threshold, that is, it is determined that the sound source positioning image is the sound source positioning image of the baby, α=score and other processing is not performed; and if the classification confidence score of the sound source positioning image is less than the preset threshold, that is, it is determined that the sound source positioning image is not the sound source positioning image of the baby, α=1 and a manual calibration result about the baby in the video is acquired. Then, the audio sample and the positioning result (the sound source positioning image or the manual calibration result) in the two situations described above are combined into the positive sample.
(b) when the sound source positioning image is not output, α=1 and the manual calibration result about the baby in the video is obtained, and the manual calibration result and the corresponding audio sample are combined into the positive sample.

All positive samples obtained above are combined into positive sample data for subsequent training of the multi-modal feature fusion model.

(2) For the negative samples:
(a) When the sound source positioning image is output, if a classification confidence score of the sound source positioning image is greater than or equal to a preset threshold, that is, it is determined that the sound source positioning image is the sound source positioning image of the baby, α=0 and other processing is not performed; and if the classification confidence score of the sound source positioning image is less than the preset threshold, that is, it is determined that the sound source positioning image is not the sound source positioning image of the baby, α=1. Then, the audio sample and the sound source positioning image in the two situations described above are combined into the negative sample.
(b) when the sound source positioning image is not output, α=1 and the manual calibration non-baby result in the video is acquired, and the manual calibration result and the corresponding audio sample are combined into the negative sample.

All negative samples obtained above are combined into negative sample data for subsequent training of the multi-modal feature fusion model.
α is a priori parameter provided by a loss function for subsequent training of the multi-modal feature fusion model.

5. Training of multi-modal feature fusion model and data processing thereof:

Each positive sample and each negative sample are subjected to the feature extraction by using the deep convolutional neural network respectively, and the training of the multi-modal feature fusion model is performed by using the following formula as a loss function;

$$loss = \frac{α}{2} {loss}_{α} + ( 1 - \frac{α}{2} ) {loss}_{v} ;$$

loss_{α} is an audio loss function and loss, is an image loss function, both of which use binary cross entropy.

By performing data cleaning on the sample data set, a clean data set is acquired for training, a proportion of the audio loss and the image loss to the total loss is dynamically adjusted, a stochastic gradient descent algorithm is utilized to optimize and solve the total loss (loss), and the fused network parameters are updated to obtain an optimal prediction model, that is, the multi-modal feature fusion model.

Further, in order to further improve the accuracy of the model, for a weak sound or no sound scene, the prediction model described above can be used as a teacher model to guide and train a student model having the same model architecture, and the formulas are as follows:

$${loss}_{student} = {loss}_{det} + λ {loss}_{consist} ;$$

$${loss}_{det} = loss ( {X}_{α} , {X}_{v} , Y ) ;$$

$${loss}_{consist} = loss ( {X}_{α} , {X}_{ν} , {\hat{C}}_{t} ) ;$$

Where, X_{α} represents the input audio features, Xᵥ represents the input image features, Y represents an input baby crying label, Ĉₜ represents a prediction of the input audio and video features from the teacher model, λ is a training hyperparameter, and λ=1 in actual use.

Therefore, the student model can update the parameters in the teacher model in the exponential moving average value manner to achieve mutual learning between the models, and a used formula is as follows:

$${w}_{t} ← β {w}_{t} + ( 1 - β ) {w}_{s} ;$$

Where, wₜ is the parameter of teacher model, wₛ is the parameter of student model, and β=0.996.

At this point, the updated teacher model is obtained, that is, the updated multi-modal feature fusion model is obtained.

### II. Baby Crying Detection Based on Training Model:

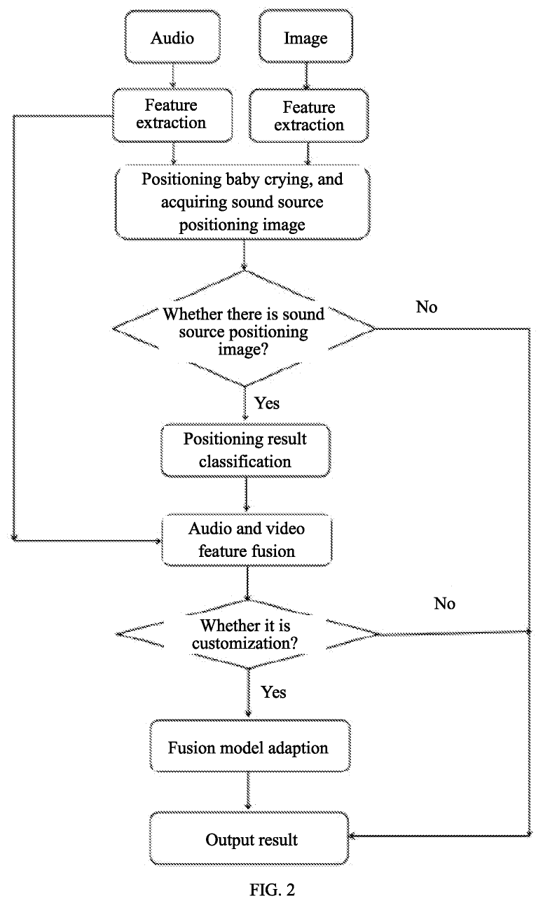

Refer to FIG. 2, FIG. 2 is a schematic flowchart of a baby crying detection method provided by the present application and an implementation process is as follows:
1. acquiring audio and video data about a target baby, and extracting and obtaining audio data and video data respectively;
2. performing feature extraction on the audio data and the video data respectively to obtain an audio feature and an image feature;
3. inputting the audio feature and the video feature into a sound source positioning model for processing; and
4. when the sound source positioning model does not output the sound source positioning image, determining that there is no crying of the target baby in the audio and video data;
5. when the sound source positioning model outputs the sound source positioning image, performing baby identification on the sound source positioning image to determine whether the sound source positioning image is a sound source positioning image about the target baby;
6. when the sound source positioning image is a sound source positioning image about a baby, fusing the sound source positioning image with the audio feature to obtain a fusion feature;
7. determining whether customized information of a user is currently received, and if not, directly retrieving the multi-modal feature fusion model for identifying process to obtain a sound detection result, so as to determine whether there is cry of the target baby in the audio and video data;
8. if the customization information of the user is received, performing a parameter fine adjustment on the multi-modal feature fusion model by using the audio and video samples of the target baby to realize model adaptation; and
9. using the adapted multi-modal feature fusion model (i.e. the optimized multi-modal feature fusion model described above) to perform the identifying process on the fusion feature and obtain a sound detection result, so as to determine whether there is crying of the target baby in the audio and video data.

It can be seen that in the sound detection method provided in the embodiment of the present application, firstly, the audio and video data is acquired, and the audio data and the image data are extracted from the audio and video data respectively; then, the audio features of the audio data and the image features of the image data are processed by using the sound source positioning model to acquire the sound source positioning image about the target object; and finally, the multi-modal feature fusion model is used to process the sound source positioning image and the audio features of the audio data, so as to determine whether there is the target sound related to the target object in the audio and video data, thereby realizing the sound detection. Obviously, this implementation method can realize the sound detection of multi-modal feature. Compared with the sound detection of a single modal feature, it can effectively reduce the problems of missed detection and false detection, so as to improve the accuracy of the sound detection results.

An embodiment of the present application provides a sound detection apparatus.

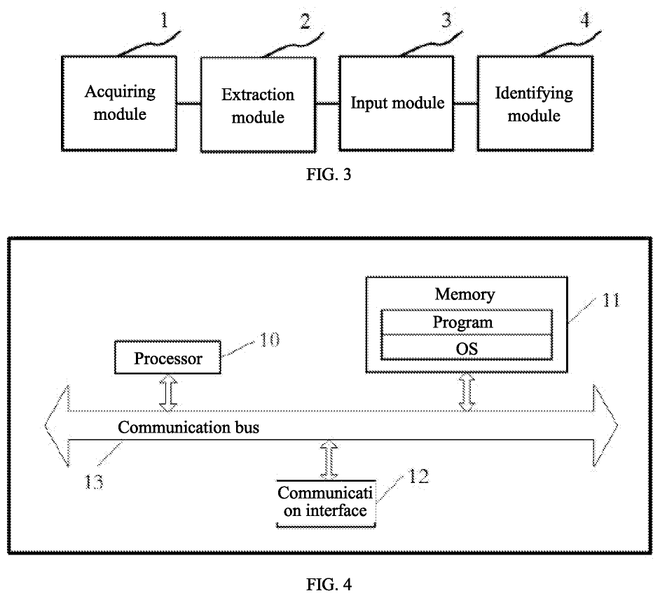

Referring to FIG. 3, FIG. 3 is a schematic structural diagram of the sound detection apparatus provided by the present application, and the sound detection apparatus may comprise:
an acquiring module 1, configured to acquire audio and video data about a target object, and extracting and obtaining audio data and image data from the audio and video data;
an extraction module 2, configured to perform feature extraction on the audio data and the image data respectively to obtain an audio feature and an image feature;
an input module 3, configured to input the audio feature and the image feature into a sound source positioning model for processing; and
identifying module 4, configured to, when the sound source positioning model outputs a sound source positioning image about the target object, identify the sound source positioning image and the audio feature by using a multi-modal feature fusion model, and determine whether target audio of the target object exists in the audio and video data.

It can be seen that in the sound detection apparatus provided in the embodiment of the present application, firstly, the audio and video data is acquired, and the audio data and the image data are extracted from the audio and video data respectively; then, the audio features of the audio data and the image features of the image data are processed by using the sound source positioning model to acquire the sound source positioning image about the target object; and finally, the multi-modal feature fusion model is used to process the sound source positioning image and the audio features of the audio data, so as to determine whether there is the target sound related to the target object in the audio and video data, thereby realizing the sound detection. Obviously, this implementation method can realize the sound detection of multi-modal feature. Compared with the sound detection of a single modal feature, it can effectively reduce the problems of missed detection and false detection, so as to improve the accuracy of the sound detection results.

In an embodiment of this application, the above extraction module 2 may be specifically used for calculating a spectral coefficient of the audio data, and performing the feature extraction on the spectral coefficient by using an audio feature extraction model to obtain the audio feature; and performing the feature extraction on the image data by using an image feature extraction model to obtain the image feature.

In an embodiment of the present application, the sound detection apparatus may also comprise a first model building block for acquiring the audio and video samples and extracting the positive audio samples, negative audio samples, positive image samples, and negative image samples from the audio and video samples; identifying each positive audio sample and obtaining the volume value; combining the positive audio samples of which the volume values are not lower than the preset threshold and the positive image samples into strong positive samples; combining the negative audio samples and negative image samples into negative samples; and training the initial sound source positioning model by using the strong positive samples and the negative samples, and obtaining the sound source positioning model.

In an embodiment of the present application, the sound detection apparatus may also include a second model building module for processing each strong positive sample and each negative sample by using the sound source positioning model, obtaining each processing result, and determining the priori parameters corresponding to each processing result, wherein the processing result includes outputting a first sound source positioning image about the target object, outputting a second sound source positioning image about other objects, and no output; when the processing result of the strong positive sample is to output the first sound source positioning image, combining the first sound source positioning image and the positive audio sample in the strong positive sample into a first positive sample; when the processing result of the strong positive sample is to output the second sound source positioning image or no output, acquiring a target object calibration result of the positive image sample in the strong positive sample, and combining the target object calibration result and the positive audio sample in the strong positive sample into a second positive sample; when the processing result of the negative sample is to output the first sound source positioning image, combining the first sound source positioning image and the negative audio sample in the negative sample into a first negative sample; when the processing result of the negative sample is to output the second sound source positioning image, combining the second sound source positioning image and the negative audio sample in the negative sample into a second negative sample; when the processing result of the negative sample is no output, acquiring other object calibration results in the negative image sample in the negative sample, and combining the other object calibration results and the negative audio samples in the negative sample into a third negative sample; combining the first positive sample and the second positive sample into a positive sample set, and combining the first negative sample, the second negative sample and the third negative sample into a negative sample set; and performing model training according to the positive sample set, the negative sample set, and all the priori parameters to obtain the multi-modal feature fusion model.

In an embodiment of the present application, the sound detection apparatus may also comprise a model update module for combining the positive audio samples with volume values lower than the preset threshold and the positive image sample data into the weak positive samples; obtaining the student model by training the multi-modal feature fusion model and weak positive samples; and updating the parameters of the multi-modal feature fusion model by using the student model, and obtaining the updated multi-modal feature fusion model.

In an embodiment of the present application, the identifying module 4 may be used specifically to determine whether the customized information has been received, wherein the customized information is target audio and video samples about the target object; if so, optimizing the multi-modal feature fusion model by using the target audio and video samples, and obtaining the optimized multi-modal feature fusion model; and using the optimized multi-modal feature fusion model to identify the sound source positioning image and audio features.

In an embodiment of the present application, the identifying module 4 may also be used for when the sound source positioning model does not output the sound source positioning image about the target object, determining that there is no target audio of the target object in the audio and video data.

For the description of the apparatus provided in the embodiments of this application, please refer to the above method embodiments, and it will not be repeated herein.

An embodiment of the present application provides an electronic device.

Refer to FIG. 4, FIG. 4 is a schematic structural diagram of the electronic device provided by the present application. The electronic device may comprise:
a memory, configured to store a computer program; and
a processor, configured to implement the steps of any sound detection method as described above when executing the computer program.

A component structure of the electronic device is as shown in FIG. 4, and the electronic device can comprise: a processor 10, a memory 11, a communication interface 12 and a communication bus 13. The processor 10, memory 11 and communication interface 12 all communicate with each other through the communication bus 13.

In the embodiment of the present application, the processor 10 may be a Central Processing Unit (CPU), an application-specific integrated circuit, a digital signal processor, a field programmable gate array, or other programmable logic device.

The processor 10 may invoke the program stored in the memory 11, and in particular, the processor 10 may perform operations in the embodiments of sound detection method.

The memory 11 is used to store one or more programs, which may comprise program codes, and program codes comprise computer operation instructions. In the embodiment of the present application, the memory 11 stores at least the program used to achieve the following functions:
acquiring audio and video data about a target object, and extracting and obtaining audio data and image data from the audio and video data;
performing feature extraction on the audio data and the image data respectively to obtain an audio feature and an image feature;
inputting the audio feature and the image feature into a sound source positioning model for processing; and
when the sound source positioning model outputs a sound source positioning image about the target object, identifying the sound source positioning image and the audio feature by using a multi-modal feature fusion model, and determining whether target audio of the target object exists in the video data.

In a possible implementation, the memory 11 may include a stored program area and a stored data area, wherein the stored program area may store the operating system and applications required for at least one function, etc.; and the storage data area can store data created during use.

In addition, the memory 11 may include a high-speed random access memory and may also include a non-volatile memory, such as at least one disk storage device or other volatile solid-state storage device.

The communication interface 12 may be an interface of the communication module and is used to connect to other devices or systems.

Of course, it should be noted that the structure shown in FIG. 4 does not constitute a restriction to the electronic device in the embodiments of this application, and that in practical applications, the electronic device may include more or fewer parts than that shown in FIG. 4, or some parts of the electronic device may be combined.

An embodiment of the present application provides a computer readable storage medium.

A computer program is stored on the computer readable storage medium provided in the embodiment of the present application, and the computer program, when executed by a processor, can implement the steps of any of the above sound detection methods.

The computer readable storage medium can include various media that can store program codes such as a U disk, a removable hard disk, a Read-Only Memory (ROM), a Random Access Memory (RAM), a magnetic disk or compact disc.

For the introduction of the computer readable storage medium provided by the embodiments of this application, please refer to the above method embodiments, and it is not detailed herein.

Each embodiment in the specification is described in a progressive manner, and each embodiment focuses on its differences from other embodiments. For the same and similar parts of each embodiment, please refer to each other. For the apparatus disclosed by the embodiment, because it corresponds to the method disclosed by the embodiment, the description is relatively simple, and a corresponding part of the method may be referred to for the relevant part.

Professionals may also further appreciate that the units and algorithmic steps of each example described in conjunction with the embodiments disclosed herein can be implemented in an electronic hardware, a computer software, or a combination of both. In order to clearly illustrate the interchangeability of the hardware and software, the constitution and steps of each example have been described generally in terms of functions in the above illustration. Whether these functions are performed in the hardware or software depends on a specific application and design constraints of the technical solution. Technical professionals may use different methods for each particular application to achieve the described functions, but such implementation should not be considered beyond the scope of this application.

The steps of the methods or algorithms described in combination with the embodiments disclosed herein may be implemented directly with a hardware, a software module executed by a processor, or a combination of both. The software module may be placed in a random access memory (RAM), a memory, a read-only memory (ROM), an electrically programmable ROM, an electrically erasable programmable ROM, registers, a hard disk, a removable disk, a CD-ROM or any other form of storage medium well-known in the technical field.

The technical solution provided in this application is described in detail above. Herein, specific examples are used to explain the principle and implementations of this application. The explanation of the above embodiments are only used to help understand the method of this application and core conception thereof. It should be noted that for a person of ordinary skill in the art, without departing from the principle of this application, several improvements and modifications can also be made to this application, and these improvements and modifications also fall within the protection scope of this application.

What is claimed is:

1. A sound detection method, comprising:
acquiring audio and video data about a target object, and extracting and obtaining audio data and image data from the audio and video data;
performing feature extraction on the audio data and the image data respectively to obtain an audio feature and an image feature;
inputting the audio feature and the image feature into a sound source positioning model for processing; and
when the sound source positioning model outputs a sound source positioning image about the target object, identifying the sound source positioning image and the audio feature by using a multi-modal feature fusion model, and determining whether target audio of the target object exists in the audio and video data.

2. The sound detection method according to claim 1, wherein the step of performing feature extraction on the audio data and the image data respectively to obtain an audio feature and an image feature comprises:
calculating a spectral coefficient of the audio data, and performing feature extraction on the spectral coefficient by using an audio feature extraction model to obtain the audio feature; and
performing the feature extraction on the image data by using an image feature extraction model to obtain the image feature.

3. The sound detection method according to claim 1, wherein a construction process of the sound source positioning model comprises:
acquiring audio and video samples, and performing extraction in the audio and video samples to obtain positive audio samples, negative audio samples, positive image samples, and negative image samples;
identifying each of the positive audio samples to obtain volume values;
combining the positive audio samples with volume values not lower than a preset threshold with the positive image samples into strong positive samples;
combining the negative audio samples and the negative image samples into negative samples; and
training an initial sound source positioning model by using the strong positive samples and the negative samples to obtain the sound source positioning model.

4. The sound detection method according to claim 3, wherein a construction process of the multi-modal feature fusion model comprises:
processing each of the strong positive samples and each of the negative samples by using the sound source positioning model to obtain each processing result, and determining a priori parameter corresponding to each processing result, wherein the processing results comprise outputting a first sound source positioning image about the target object, outputting a second sound source positioning image about other objects, and no output;
when the processing result of the strong positive sample is to output the first sound source positioning image, combining the first sound source positioning image and the positive audio sample in the strong positive sample into a first positive sample;
when the processing result of the strong positive sample is to output the second sound source positioning image or no output, acquiring a target object calibration result of the positive image sample in the strong positive sample, and combining the target object calibration result and the positive audio sample in the strong positive sample into a second positive sample;
when the processing result of the negative sample is to output the first sound source positioning image, combining the first sound source positioning image and the negative audio sample in the negative sample into a first negative sample;
when the processing result of the negative sample is to output the second sound source positioning image, combining the second sound source positioning image and the negative audio sample in the negative sample into a second negative sample;
when the processing result of the negative sample is no output, acquiring other object calibration results in the negative image sample in the negative sample, and combining the other object calibration results and the negative audio samples in the negative sample into a third negative sample;
combining the first positive sample and the second positive sample into a positive sample set, and combining the first negative sample, the second negative sample and the third negative sample into a negative sample set; and
performing model training according to the positive sample set, the negative sample set, and all the priori parameters to obtain the multi-modal feature fusion model.

5. The sound detection method according to claim 4, wherein the method further comprises:
combining the positive audio samples with the volume values lower than the preset threshold with the positive image sample data into weak positive samples;
performing training by using the multi-modal feature fusion model and the weak positive samples to obtain a student model; and
performing parameter updating on the multi-modal feature fusion model by using the student model to obtain an updated multi-modal feature fusion model.

6. The sound detection method according to claim 1, wherein the step of identifying the sound source positioning image and the audio feature by using a multi-modal feature fusion model comprises:
determining whether customization information is received, where the customization information is a target audio and video sample about the target object;
if yes, performing model optimization on the multi-modal feature fusion model by using the target audio and video sample to obtain an optimized multi-modal feature fusion model; and
identifying the sound source positioning image and the audio feature by using the optimized multi-modal feature fusion model.

7. The sound detection method according to claim 1, wherein the method further comprises:
when the sound source positioning model does not output the sound source positioning image about the target object, determining that there is no target audio of the target object in the audio and video data.

8. A sound detection apparatus, comprising:
an acquiring module, configured to acquire audio and video data about a target object, and extracting and obtaining audio data and image data from the audio and video data;
an extraction module, configured to perform feature extraction on the audio data and the image data respectively to obtain an audio feature and an image feature;
an input module, configured to input the audio feature and the image feature into a sound source positioning model for processing; and
an identifying module, configured to, when the sound source positioning model outputs a sound source positioning image about the target object, identify the sound source positioning image and the audio feature by using a multi-modal feature fusion model, and determine whether target audio of the target object exists in the audio and video data.

9. An electronic device, comprising:
a memory, configured to store a computer program; and
a processor, configured to implement the steps of the sound detection method according to claim 1 when executing the computer program.

10. A computer-readable storage medium, wherein the computer-readable storage medium stores a computer program, and the computer program, when being executed by a processor, implements the steps of the sound detection method according to claim 1.
